(19) United States
(12) Patent Application Publication
(10) Pub. No.: US 2020/0173045 A1
(43) Pub. Date: Jun. 4, 2020

(54) N- and O-Doped Carbon with High Selectivity for Electrochemical H2O2 Production in Neutral Condition

(71) Applicant: The Board of Trustees of the Leland Stanford Junior University, Stanford, CA (US)

(72) Inventors: Guangxu Chen, Menlo Park, CA (US); Zhiyi Lu, San Jose, CA (US); Yi Cui, Stanford, CA (US)

(21) Appl. No.: 16/631,120

(22) PCT Filed: Aug. 23, 2018
(86) PCT No.: PCT/US2018/047739

§ 371 Date: Jan. 14, 2020

Related U.S. Application Data
(60) Provisional application No. 62/549,256, filed on Aug. 23, 2017.

(51) Int. Cl. C25B 11/12; C02F 1/467; C25B 1/30; C02F 1/461; C25B 11/03

(52) U.S. Cl. CPC C25B 11/12; C02F 1/4672; C25B 1/30; C02F 2303/04; C25B 11/035; C02F 2001/46142; C02F 2001/46161; C02F 1/46109

(57) ABSTRACT

Improved electrochemical production of hydrogen peroxide is provided with a mesoporous carbon catalyst is both O- and N-doped. The resulting catalyst works pH-neutral solutions to enable applications such as environmental water treatment.

### FIELD OF THE INVENTION

This invention relates to electrochemical production of hydrogen peroxide in neutral solutions.

### BACKGROUND

Hydrogen peroxide (H₂O₂) is a highly valuable chemical in many fields of chemical industry, food, energy and environmental protection. Since conventional production of hydrogen peroxide is an energy-intensive process, considerable recent efforts have been devoted to efficient methods for H₂O₂ production. One safe, attractive and promising strategy for H₂O₂ production is electrochemical oxygen reduction through two-electron pathway.

Catalysts with high selectivity for H₂O₂ production via this electrochemical approach have been achieved to some extent. The activity of the catalyst for the oxygen reduction reaction to produce H₂O₂ is highly dependent on the pH value of the electrolyte, and work to date has demonstrated good results only in acid or basic electrolytes. Thus selective production of H₂O₂ in neutral condition is still a great challenge because of the lack of efficient catalysts. Since the pH value of most waste water is close to 7, a pH-neutral process can provide on-site generation of H₂O₂ for water disinfection, and thus the potential danger caused by the transportation and storage of H₂O₂ can be eliminated. Therefore, it is highly desirable to develop a catalyst for H₂O₂ production in neutral condition.

### SUMMARY

We report a facile one-pot synthesis of a N- and O-doped carbon catalyst with high oxygen reduction activity (6.6 mA mg⁻¹ at 0.6 V vs. RHE (reversible hydrogen electrode)) and the highest H₂O₂ yield (96%) in neutral medium. In one example, the N- and O-doped carbon catalyst was derived from the carbonization of ethylenediaminetetraacetic acid (EDTA) which is low cost and contains moderate nitrogen content (9.6%). Such unprecedented catalytic activity and selectivity of the N- and O-doped carbon catalyst toward electrochemical H₂O₂ generation was attributed to the synergetic effect from nitrogen and oxygen species on the catalyst. This N- and O-doped carbon showed the best activity and selectivity for H₂O₂ generation in neutral electrolyte.

The main applications of this N- and O-doped carbon catalyst is for electrochemical H₂O₂ generation from oxygen reduction reaction at neutral electrolyte. The generated H₂O₂ can be used for environment protection and water or food disinfection.

Significant advantages are provided. 1) This N- and O-doped carbon catalyst can be derived from the carbonization of ethylenediaminetetraacetic acid (EDTA) in melted potassium hydroxide, which is very cheap and simple. 2) The activity and selectivity of this N- and O-doped carbon catalyst showed the best activity and selectivity in electrochemical H₂O₂ generation in neutral electrolyte.

Several variations are possible. 1) The precursors, including ethylenediaminetetraacetic acid or its similar structures (i.e. carbon precursor), and potassium hydroxide or its similar base (i.e., base precursor). See below for alternate carbon precursors and base precursors. 2) The mass ratio of the precursors between the carbon precursor and the base precursor. 3) The reaction temperature, ranging from 400-1000 degree C. 4) The reaction atmosphere, usually under nitrogen or argon. 5) The contents of nitrogen and oxygen in the catalyst.

Significant features include the following: The structure of the N- and O-doped carbon catalyst. Both nitrogen and oxygen are useful for the catalyst, and such unprecedented catalytic activity and selectivity of the N- and O-doped carbon catalyst toward electrochemical H₂O₂ generation was attributed to the synergetic effect from nitrogen and oxygen species on the catalyst.

### BRIEF DESCRIPTION OF THE DRAWINGS

FIG. 1 shows an exemplary electrochemical cell.

FIG. 2A schematically shows catalysis of hydrogen peroxide production.

FIGS. 2B-D show images and characterization results from the catalyst of this work.

FIGS. 3A-C show hydrogen peroxide production results from exemplary experiments.

FIGS. 4A-B shows XPS results for catalysts of this work.

FIGS. 4C-F show hydrogen peroxide production results from further experiments.

FIGS. 5A-B show disinfection results from exemplary experiments.

FIG. 6 shows a cross-sectional SEM image of the N- and O-doped carbon microsheet.

FIG. 7 shows XRD analysis of N- and O-doped carbon catalyst.

FIG. 8 shows the XPS survey spectrum over N- and O-doped carbon.

FIG. 9 shows results of a stability test of N- and O-doped carbon catalyst for ORR.

FIGS. 10A-C show high resolution of XPS of N1s from N- and O-doped carbon catalysts with different N/C ratio.

FIGS. 11A-C show results relating to an N- and O-doped carbon catalyst with melamine as the precursor.

### DETAILED DESCRIPTION

Section A describes general principles relating to various embodiments of the invention. Section B describes in detail an experimental demonstration of principles of the invention.

### A) General Principles

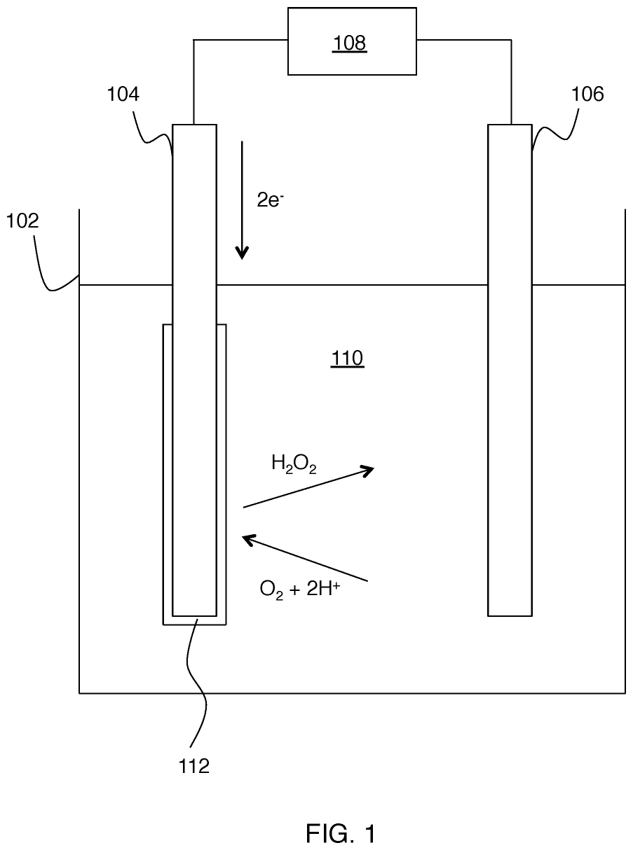

FIG. 1 shows an electrochemical cell suitable for practicing embodiments of the invention. More specifically, electrochemical cell 102 includes an electrolyte 110, a first electrode 104 and a second electrode 106. An electrical source 108 drives current flow as shown to produce H₂O₂. Although the specific reaction shown here is a two electron oxygen reduction reaction, other electrochemical reactions that also produce H₂O₂ may also proceed. Two aspects of this arrangement are especially significant. The first aspect is that electrolyte 110 is pH-neutral, defined herein as having a pH in the range from 6 to 8. The second aspect is that catalyst 112 is configured to efficiently catalyze production of H₂O₂ with such a neutral electrolyte. Further details relating to the catalyst are described below and in section B.

Accordingly, one embodiment of the invention is a method of generating hydrogen peroxide in a pH neutral solution. Here the method includes:
a) providing an electrochemical reaction cell;
b) providing a mesoporous carbon catalyst including both nitrogen doping and oxygen doping in the electrochemical reaction cell; and
c) providing electrical current to the electrochemical reaction cell to drive an oxygen reduction reaction that produces hydrogen peroxide.
   Here the oxygen reduction reaction is catalyzed by the mesoporous carbon catalyst, and mesoporous is defined as a porous structure having pores with diameters between 2 nm and 50 nm.

Applications of this method include producing H₂O₂ to provide treatment of environmental water. Such treatment can be any combination of disinfection and/or chemical degradation of pollutants.

Another embodiment of the invention is a method of making a catalyst for the electrochemical production of hydrogen peroxide. Here the method includes:
a) providing a nitrogen-containing organic precursor; and
b) carbonizing the nitrogen-containing organic precursor with a base to provide a mesoporous carbon catalyst including both nitrogen doping and oxygen doping.

The nitrogen-containing organic precursor can have a chemical structure given by

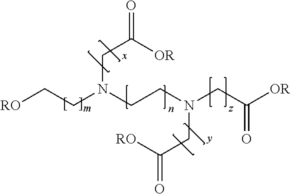

where n≥1, m≥1, x≥1, y≥1, z≥1, and where each R is independently selected from the group consisting of: H, hydrocarbon group, alkali metal (Li, Na, K, Rb, Cs) ion and alkaline earth metal (Be, Mg, Ca, Sr, Ba) ion.

Practice of the invention does not depend critically on the base used to carbonize the precursor. Suitable bases include but are not limited to: potassium hydroxide (KOH), sodium hydroxide (NaOH), lithium hydroxide (LiOH), rubidium hydroxide (RbOH), caesium hydroxide (CsOH), ammonium hydroxide (NH₄OH), beryllium hydroxide (BeOH), magnesium hydroxide (Mg(OH)₂), and calcium hydroxide (Ca(OH)₂).

The carbonizing the nitrogen-containing organic precursor with a base is preferably performed at a temperature in a range from 600° C. to 900° C.

Another embodiment of the invention is a mesoporous carbon catalyst including both nitrogen doping and oxygen doping, where the catalyst is configured to catalyze an electrochemical oxygen reduction reaction for the production of hydrogen peroxide in a pH neutral solution. A further embodiment is an electrochemical cell (e.g., as shown on FIG. 1) including such a catalyst.

The catalyst is preferably configured as porous microsheets of amorphous carbon including nano-scale graphitized domains. Here micro-sheets are defined as structures having one dimension of 1 micron or less with the other two dimensions being 5 microns or more, and nano-scale domains are defined as having a largest dimension of 1 micron or less.

The nitrogen content and oxygen content of the catalyst are preferably both greater than 1%. Preferably, no transition metal (elements 21-29, 39-47, 57-79) catalyst is included in the mesoporous carbon catalyst.

The nitrogen doping can be included in the mesoporous carbon catalyst in various chemical configurations, including but not limited to pyrrolic and pyridinic configurations and mixtures thereof. Here a nitrogen atom is in a pyrrolic configuration if an NH group is part of a five-member aromatic ring, e.g. as in pyrrole (C₄H₄NH). A nitrogen atom is in a pyridinic configuration if an N atom substitutes for a CH group in a six-member aromatic ring, e.g. as in pyridine (C₅H₅N). In XPS spectroscopy of N1s, pyridinic nitrogen has a peak at 398.5 eV and pyrrolic nitrogen has a peak at 400.1 eV.

### B) Experimental Example

### B1) Introduction

Hydrogen peroxide (H₂O₂) is a highly valuable chemical in many fields of chemical industry, food, energy and environmental protection. Additionally, H₂O₂ is a strong oxidant and the only degradation of its use is water, which make it widely used for the degradation of refractory pollutants in aquatic environment as well as water disinfection. In industry, the demand of the H₂O₂ is met by a sequential process of hydrogenation and oxidation of substituted anthraquinone, which is an energy-intensive process and can hardly be considered as an environmentally benign method. In recent years, considerable efforts have been dedicated to develop efficient methods for H₂O₂ production. Direct synthesis of H₂O₂ has been achieved by converting elemental hydrogen and oxygen into H₂O₂ on various catalysts in heterogeneous reactions. However, such a process would involve potential danger of explosion. Another safe, attractive and promising strategy for H₂O₂ production is electrochemical oxygen reduction through two-electron pathway (ORR, oxygen reduction reaction). With the use of theoretical simulation and sophisticated synthesis techniques, catalysts with high selectivity for H₂O₂ production have been achieved to some extent in the literature.

Actually, the activity of the catalyst for ORR to produce H₂O₂ is highly dependent on the pH value of the electrolyte. Noble metal-based catalysts (e.g. Pd—Au, Pt—Hg) have been identified to primarily proceed two-electron pathway in acid condition with selectivity of more than 90%, but the scarcity and the high cost may hinder their large-scale applications. And heavy metal pollution from the catalyst itself also needs to be considered. Carbon-based materials have recently emerged as low cost and highly active catalysts for oxygen reduction in base or acid electrolytes. In addition, the reaction pathways (two-electron or four-electron pathways) of oxygen reduction can be fine-tuned by structure modulation or selectively doping carbon with heteroatoms (e.g. Fe, N, S). Despite this progress, selective production of H₂O₂ in neutral condition is still a great challenge because the lack of efficient catalysts. As the pH value of most waste water is close to 7, this process can provide an on-site generation of H₂O₂ for water disinfection, and thus the potential danger caused by the transportation and storage of H₂O₂ can be eliminated. Therefore, it is highly desirable to develop a novel carbon-based material with high activity and selectivity for H₂O₂ production in neutral condition.

### B2) Technical Approach

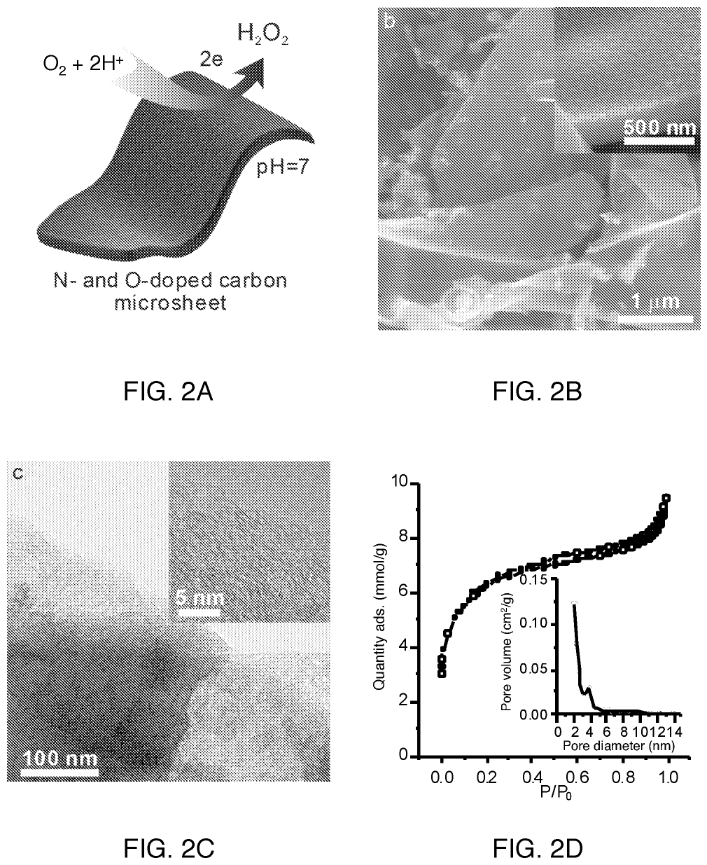

Herein, we report a facile one-pot synthesis of a N- and O-doped carbon catalyst with high oxygen reduction activity (6.6 mA mg⁻¹ at 0.6 V vs. RHE) and the highest H₂O₂ yield (96%) in neutral medium (FIGS. 1 and 2A). The N- and O-doped carbon catalyst was derived from the carbonization of ethylenediaminetetraacetic acid (EDTA) which is low cost and contains moderate nitrogen content (9.6%). Such unprecedented catalytic activity and selectivity of the N- and O-doped carbon catalyst toward electrochemical H₂O₂ generation was attributed to the synergetic effect from nitrogen and oxygen species on the catalyst. Moreover, we demonstrated a system for on-site electrochemical generation of H₂O₂ for water disinfection with an excellent efficiency of >99.999%.

FIG. 2A shows the scheme of electrochemical generation of H₂O₂ using N- and O-doped carbon catalyst. FIG. 2B shows representative SEM images of N- and O-doped carbon microsheet. FIG. 2C shows TEM and HRTEM images of N- and O-doped carbon microsheet. FIG. 2D shows the type IV nitrogen sorption isotherm. The insert is pore size characteristics of N- and O-doped carbon via Barrett-Joyner-Halenda (BJH) model.

### B3) Catalyst Fabrication and Characterization

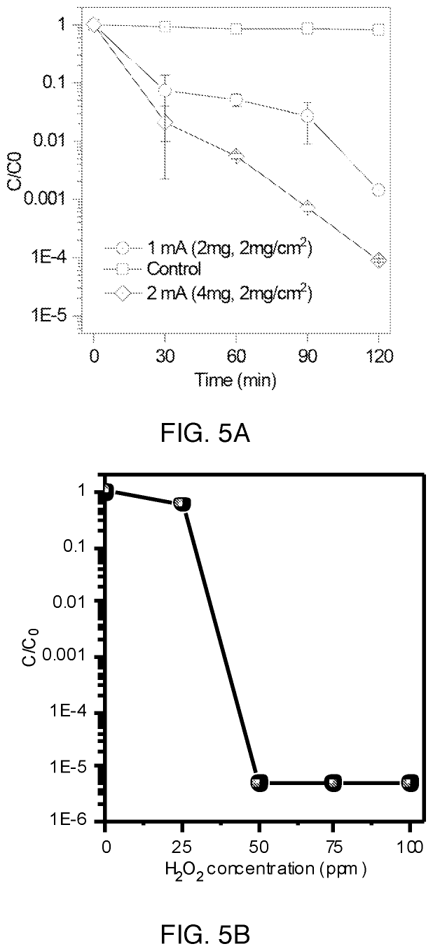

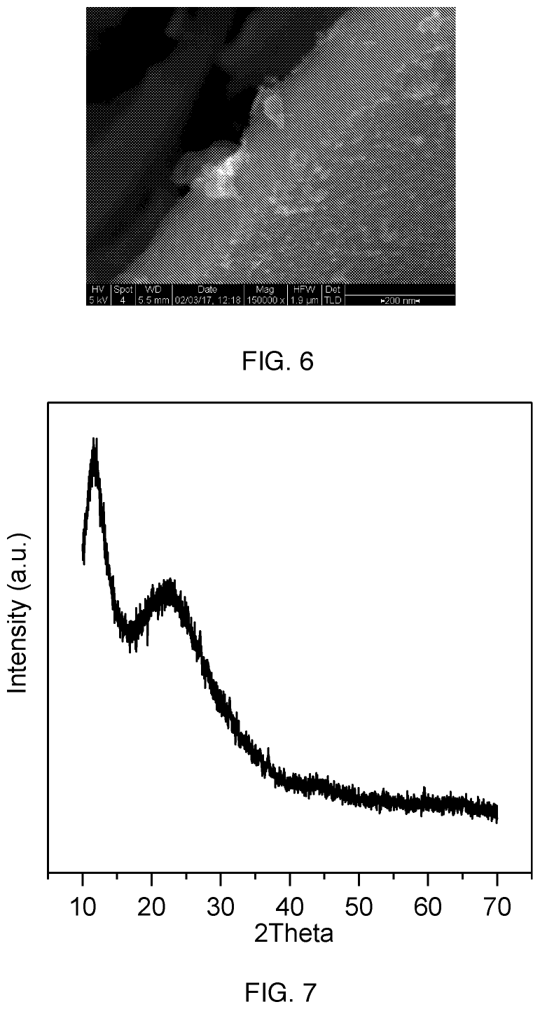

A facile one-pot synthesis of N- and O-doped carbon catalyst was carried out by carbonizing ethylenediaminetetraacetic acid (EDTA) in melted potassium hydroxide (KOH) under argon atmosphere (see below for details). The resulting product was collected by centrifugation and washed with diluted nitric acid and deionized water for several times. The as-prepared N- and O-doped carbon catalyst was first characterized by scanning electron microscopy (SEM). As shown in the SEM images in FIG. 2B, the product was mainly formed of carbon microsheets. The SEM images (FIG. 2B insert and FIG. 6) at a higher magnification demonstrated that the microsheets were highly porous. Transmission electron microscopy (TEM) studies (FIG. 2C) revealed the amorphous structure of carbon microsheets, which is consistent with the analysis of X-ray diffraction (XRD) (FIG. 7). However, high resolution TEM (HRTEM) image (FIG. 2C insert) demonstrated that the N- and O-doped carbon included many graphitized carbon domains in nanosize, which indicates that the N- and O-doped carbon would have a high surface area.

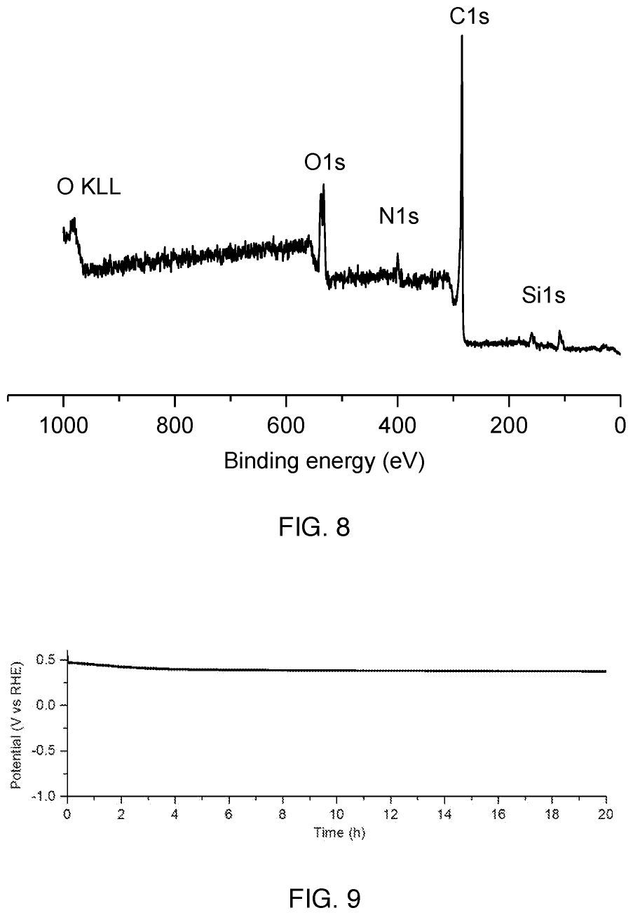

N₂ adsorption-desorption isothermal analysis on N- and O-doped carbon confirmed the high specific surface area of ˜494 m²g⁻¹ (FIG. 2D) by using the Brunauer-Emmett-Teller method. A type-IV isotherm with a hysteresis at high relative pressure (p/p₀>0.5) was observed, which is indicative of mesoporous materials (FIG. 2D). The pore size distribution analysis via Barrett-Joyner-Halenda (BJH) method revealed that the dominant pore size in the N- and O-doped carbon was about 3.9 nm (FIG. 2D insert), corresponding well with the TEM observation. As the nitrogen content is directly corresponding to the catalytic performance of the N- and O-doped carbon catalysts, X-ray photoelectron spectroscopy (XPS) and elemental analysis (EA) measurements were carried out to determine the nitrogen and oxygen contents of the N- and O-doped carbon microsheets. The nitrogen content of the N- and O-doped carbon microsheets is about 1.8% from XPS measurement, which is a little different from the EA (2.0%) analysis. The variation of the values is mainly due to the surface specificity of XPS measurements. The content of the oxygen is ˜14.8%. It's noteworthy that no metal was found in the N- and O-doped carbon material while performing the survey measurement (FIG. 8).

B4) H₂O₂ Production Results

The electrochemical measurements of the oxygen reduction reaction were conducted in a standard three-compartment electrochemical cell using an interchangeable rotating ring-disk electrode connected with a rotation control (Pine Instruments) and a Biologic VSP potentiostat. To quantify the amount of H₂O₂ formed, the Pt ring electrode was potentiostated at 1.2 V (vs. RHE, the same as below) where the oxygen reduction current is negligible and H₂O₂ oxidation is diffusion limited. An aliquot of the catalyst suspension which was prepared with ethanol, 2-propanol and Nafion solution was deposited onto a well-polished glassy carbon electrode and measured in the O₂-saturated PBS (phosphate-buffered saline) solution (pH=7). A polarization curve at voltage between 0-1.0 V and the corresponding cyclic voltammogram (CV) in deaerated PBS solution were recorded. The background of the polarization curve was corrected by the CV which is measured in deaerated PBS solution. For comparison, commercially available carbon black (C65, amorphous carbon) was also measured under the same condition.

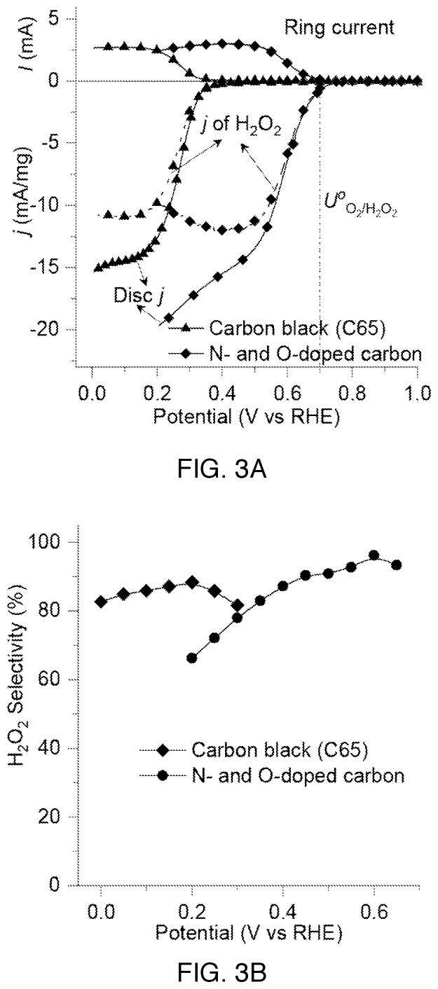

FIGS. 3A-C show electrocatalytic performance of N- and O-doped carbon catalyst for oxygen reduction in neutral mediate. FIG. 3A shows RRDE voltammograms run at 1,600 rpm. in O₂-saturated 0.1 M PBS solution (pH=7) with N- and O-doped carbon and commercially available carbon black C65, including disc current density, ring current and current density corresponding to hydrogen peroxide obtained from the ring current. FIG. 3B shows the corresponding selectivity of H₂O₂ generated in oxygen reduction reaction over N- and O-doped carbon and carbon black C65. FIG. 3C shows the concentration of H₂O₂ generated from oxygen reduction reaction with N- and O-doped carbon catalyst as a function of electrolysis time in PBS solution. The potential was ˜0.6 V (vs. RHE).

As illustrated in FIG. 3A, commercial carbon black

(C65) displayed negligible activity for ORR in PBS solution. Oxygen reduction occurred only when the potential was below 0.35 V (FIG. 3A). In sharp contrast, the N-doped catalyst started to show ORR current at ˜0.7 V (almost ˜0 mV overpotential), indicating that the N- and O-doped carbon catalyst is much more active than carbon black. Moreover, we observed that the current densities from disc and ring coincide at the potential between 0.55-0.7 V for N- and O-doped carbon catalyst, which implies that the ORR prefers two-electron pathway within this potential range and the formation of H₂O₂ is favored. Within this potential range, the largest H₂O₂ current density of ˜10 mAmg⁻¹ was achieved (FIG. 3A). As demonstrated in FIG. 3B, the efficiency of H₂O₂ production is higher than 90% at the potential between 0.4-0.65 V, whereas no ORR current can be observed on commercial carbon black. The highest efficiency of ˜96% was achieved at the potential of 0.6 V with a current density of 6.5 mAmg⁻¹. It is found that both the current density and selectivity of H₂O₂ production started to decrease at potentials below 0.4 V, implying that the formation of water is favored.

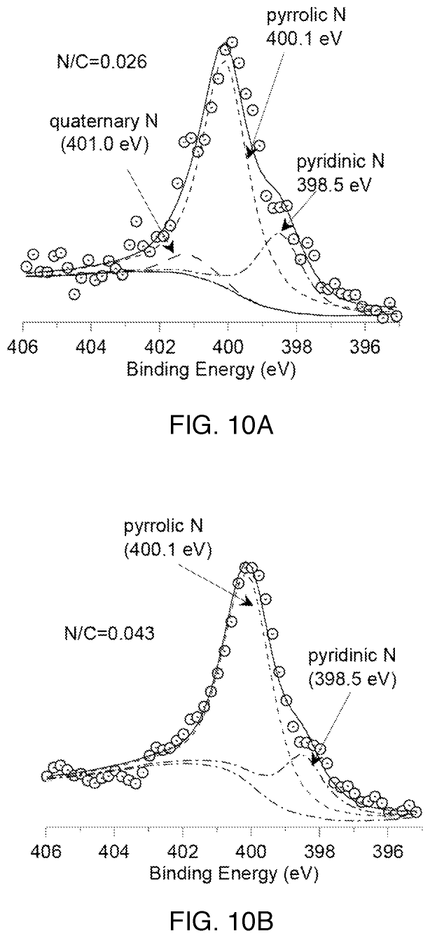

Furthermore, the stability of N- and O-doped carbon catalyst was tested by loading the catalyst on carbon fiber paper. An impressive ORR stability is shown in FIG. 9 with 4 mAcm⁻¹ cathodic current at 0.4 V for over 20 hours without obvious degradation. As on-site generation of H₂O₂ is particularly useful in water disinfection, the real amount of H₂O₂ production was tested. FIG. 3C shows the plots of accumulated H₂O₂ concentration versus electrolysis time, which reflects a quasi-linear relationship between the amount of H₂O₂ and electrolysis time. A H₂O₂ concentration of 225 mgL⁻¹ was achieved in 3 hours with an average generation rate of 75 mgL⁻¹h⁻¹.

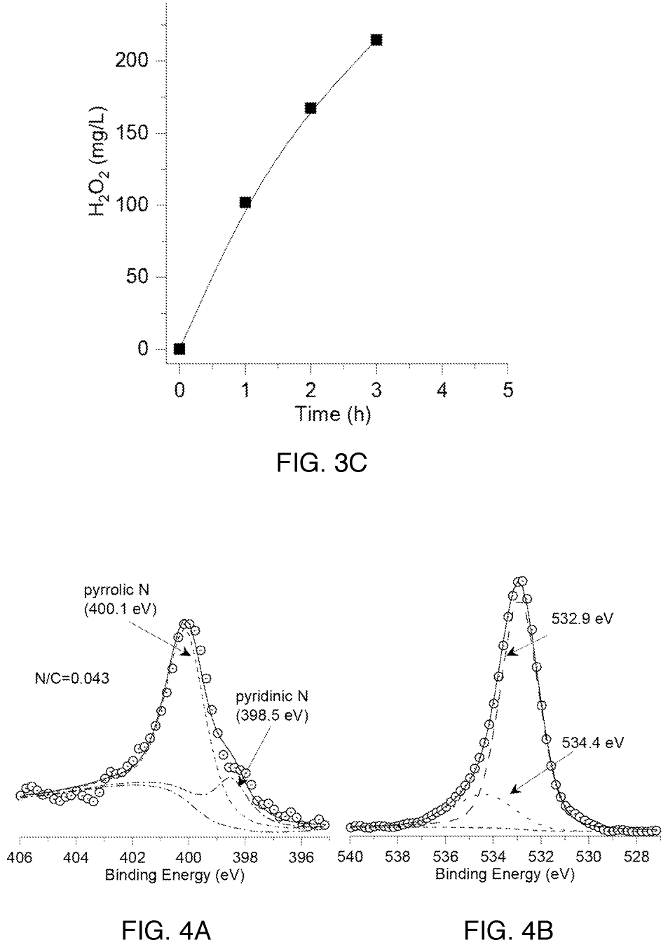

FIGS. 4A-F show effects from nitrogen and oxygen species on the catalytic performance of ORR. FIGS. 4A-B are high resolution XPS of N1s and O1s on N- and O-doped carbon catalyst. FIG. 4C shows RRDE voltammogram measurements of N-doped catalysts with different nitrogen contents. FIG. 4D shows the corresponding selectivity of H₂O₂ generated in oxygen reduction reaction over N- and O-doped carbon catalysts with different nitrogen contents. FIG. 4E shows RRDE voltammogram measurements of N-doped catalyst before and after H₂ (5% H₂ in argon) reduction at 700° C. for 1 h. FIG. 4F shows the corresponding selectivity of H₂O₂ generated in oxygen reduction reaction over N- and O-doped carbon catalysts before and after H₂ (5% H₂ in argon) reduction at 700° C. for 1 h.

To investigate the effects of dopants on the electrochemical properties of the catalyst, high-resolution XPS measurement was performed on the N-doped catalyst. As showed in FIGS. 4A-B, both the signals of nitrogen and oxygen were found. Nitrogens are present in the structures of pyridinic (11.6% at 398.5 eV) and pyrrolic (88.4% at 400.1 eV) nitrogens (FIG. 4A). The structures of oxygens are COOH (oxygen atoms in carboxyl groups, 17%, 534.4 eV) and —O— (carbonyl oxygen atoms in esters, anhydrides and oxygen atoms in hydroxyl groups, 83%, 532.9 eV) (FIG. 4B), respectively. Previous studies for discussing the oxygen effect are rare, but several studies showed that nitrogen doping could significantly enhance the ORR activity of carbon catalyst. Several research groups have reported that pyridinic N was the active site to enhance the ORR activity, where some others suggested that quaternary N was responsible for the high ORR activity of N- and O-doped carbon catalysts. Thus, the exact catalytic role of the doped nitrogen as well as the active sites are still matters of controversy. Moreover, in most of these cases, the catalysts were evaluated in base or acid electrolytes and the four-electron pathway was favorable. A theoretical calculation in the literature indicated that carbon radical sites formed adjacent to quaternary N in graphite were illustrated as the active site for O₂ electroreduction to H₂O₂. However, in our case, beside pyridinic and pyrrolic nitrogens, no obvious quaternary N at 401.0 eV and oxidic N at 402.9 eV were observed. Therefore, the pyridinic and pyrrolic nitrogens are believed to be responsible for the excellent catalytic performance.

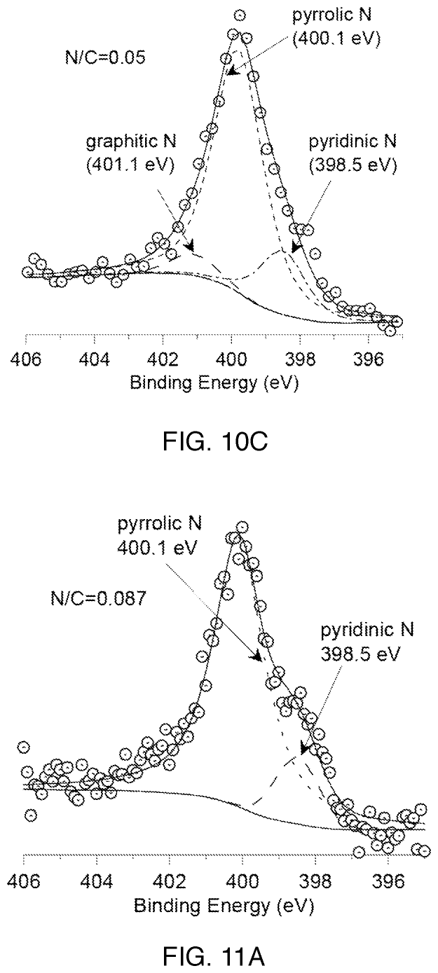

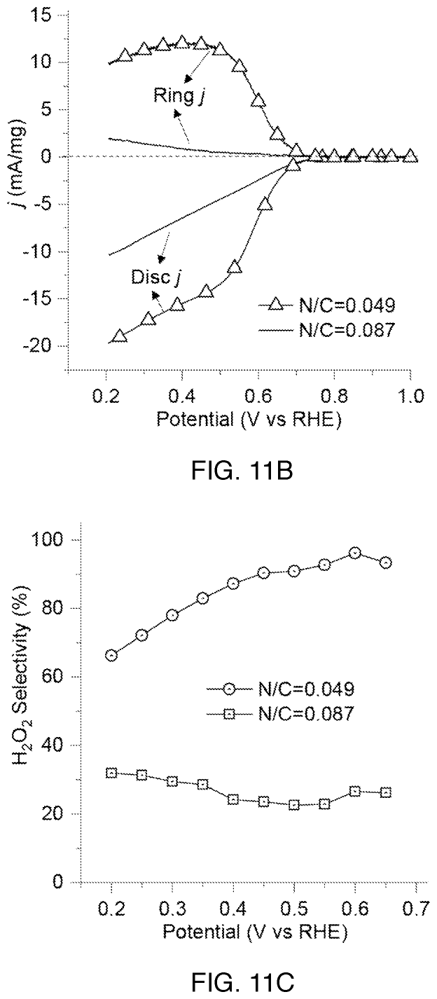

As the nitrogen doping played a critical role in the catalytic performance of the catalyst, N- and O-doped carbon with different N/C ratios (0.026, 0.043 and 0.050) were prepared. The doped nitrogen species are similar in all samples while only small amount of quaternary N was found on the N- and O-doped carbon with N/C rations of 0.026 and 0.050 (FIGS. 10A-C), but the quaternary N did not improve the catalytic performance. It is found that the N- and O-doped carbon with N/C ratio of 0.043 showed the best H₂O₂ selectivity up to 96% (FIGS. 3A-B). However, although decreasing the nitrogen content (N/C=0.026) would increase both the kinetic current density and diffusion-limiting current density of the catalyst, H₂O₂ current density was decreased and finally resulted in a lower H₂O₂ selectivity (FIGS. 4C-D). Increasing the nitrogen content (N/C=0.050) resulted in a lower ORR activity and lower H₂O₂ current density, which similarly showed a lower H₂O₂ selectivity. Further increase of the nitrogen content (N/C=0.087) while keeping the same N structure by introducing melamine as the precursor when prepared the N- and O-doped carbon resulted in an even lower activity and H₂O₂ selectivity (FIGS. 11A-C). Therefore, in our case, we conclude that proper amount of N-doping is the main reason for achieving both high activity and selectivity for electrochemical H₂O₂ production.

Further study demonstrated that oxygen doping was also necessary to achieve the high selectivity of H₂O₂. Once the oxygen species were reduced by hydrogen reduction, the carbon catalyst become much more active with an onset potential of 0.8V (vs. RHE) (FIG. 4E), but the corresponding selectivity of H₂O₂ was decreased (FIG. 4F). High resolution XPS analysis of the reduced carbon catalyst showed that the nitrogen content was almost retained while 4.6% oxygen was reduced, which suggested that oxygen species played a critical role in the catalyst to achieve the high selectivity of H₂O₂. The special functions of the oxygen doping may be originated from the oxygen functional groups or the defects. Therefore, the unprecedented catalytic activity and selectivity of the N- and O-doped carbon catalyst toward electrochemical H₂O₂ generation was attributed to the synergetic effect from nitrogen and oxygen species on the catalyst.

B5) H₂O₂ Disinfection Results

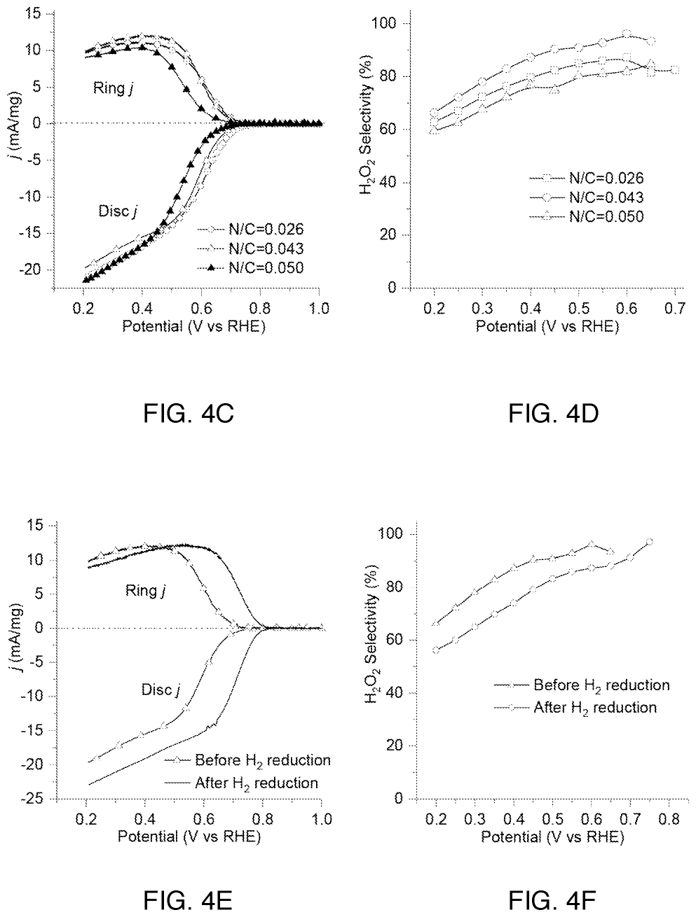

FIGS. 5A-B show electrochemical water disinfection by using N- and O-doped carbon catalyst. FIG. 5A shows disinfection performances of N- and O-doped carbon catalyst with different current densities. The measurements were carried out directly by culturing the bacteria in electrochemical cell which is running the ORR with N- and O-doped carbon catalyst for H₂O₂ generation. FIG. 5B shows water disinfection by using different concentration H₂O₂ generated from ORR with N- and O-doped carbon catalyst. The N- and O-doped carbon catalyst was loaded on carbon fiber paper with a loading of 2 mgcm⁻².

As H₂O₂ is an environmentally benign strong oxidant for water disinfection, electrochemical in situ and ex situ water disinfection experiments were carried out with our highly active N- and O-doped carbon catalyst in PBS solution (pH=7). The Gram-negative bacterium E. coli was used as model bacteria in all the experiments. The bacterial concentration at each time point of the experiment was normalized to the starting concentration and the results are shown in FIGS. 5A-B. For in situ water disinfection, bacterium E. coli was cultured in negative site where H₂O₂ was produced via ORR. The negative electrode and positive electrode was separated by proton exchange membrane (Nafion). As showed in FIG. 5A, no obvious disinfection efficiency was found without applying any current. Once 1 mA current was applied, a disinfection efficiency of 99.86% was achieved within 120 min. Further increase of the current (2 mA) resulted in a higher disinfection efficiency of 99.991% in 120 min. For ex situ water disinfection, the bacterium E. coli was cultured with the premade H₂O₂ solution through electrochemical ORR. As showed in FIG. 5B, a disinfection efficiency of 99.9995% was achieved in 120 min when the H₂O₂ concentration was larger than 50 ppm, after which the bacteria could not be detected and no recovery was observed. Based on both the in situ and ex situ water disinfection above, on-site generation of H₂O₂ for drinking water disinfection is promising.

In conclusion, we have demonstrated the synthesis of novel nitrogen doped mesoporous carbon which showed efficient electrocatalytic activity toward ORR and highly selective (96%) for H₂O₂ production in neutral condition. The effects of dopants (N and O) in the carbon catalysts on the catalytic activities were carefully investigated, and a synergetic effect of nitrogen and oxygen species in the carbon catalyst was attributed to the high activity and selectivity for H₂O₂ production via electrochemical ORR. In addition, an excellent water disinfection performance with efficiency >99.999% was demonstrated by using our electrochemically generated H₂O₂. Such an excellent performance shows great potential in the application of drinking water disinfection.

### B6) Methods

B6a) Reagents: Ethylenediaminetetraacetic acid (EDTA), Potassium hydroxide (KOH), Monosodium phosphate (NaH₂PO₄) and Disodium phosphate (NaH₂PO₄) were purchased from Sigma Aldrich. Hydrochloride acid (HCl) and ethanol were purchased from Fisher Chemical. High purity Ar (99.999%), O₂(99.998%) and N₂ (99.99%) were purchased from Airgas. Ultrapure water (Millipore, ≥18 MΩcm). All reagents were used as received without further purification.

B6b) Synthesis of N- and O-doped carbon catalysts: In a typical synthesis of N- and O-doped carbon catalyst, 2 g of EDTA and 4 g of KOH were mixed together and grinded for 10 min in the mortar. The well-mixed mixture was transferred into a combustion boat and then calcined in tube furnace at 700° C. under argon atmosphere for 2 hours. The sample was ramped from room temperature to 700° C. with a ramping rate of 10° C./min. After calcination, the product was washed with deionized water and 0.5 M hydrochloride acid solution to remove KOH and then dried in vacuum oven at 60° C. overnight.

B6c) Materials characterization: TEM studies were performed on a TECNAI F-20 high-resolution transmission electron microscopy operating at 200 kV. The samples were prepared by dropping ethanol dispersion of samples onto 300-mesh carbon-coated copper grids and immediately evaporating the solvent. SEM studies were performed on FEI XL30 Sirion to characterize the morphology and microstructure of the carbon catalysts. X-ray diffraction (XRD) measurements were recorded on a PANalytical X′pert PRO diffractometer using Cu K_{α} radiation, operating at 40 kV and 30 mA. X-ray photoelectron spectroscopy (XPS) measurements were carried out on SSI SProbe XPS spectrometer with Al K_{α} source (1486.6 eV). Binding energies reported herein are with reference to C (1s) at 284.5 eV. Electrochemical studies were carried out in a standard three-electrode cell connected to a Biologic VMP3 multi-channel electrochemical workstation. Counter electrode was an ultrapure graphite rod (6 mm in diameter) and reference electrode was a Ag/AgCl electrode. Working electrode was a rotating ring-disk electrode (RRDE) with Pt ring and glassy carbon disk (GC, φ=5 mm) purchased from Pine Instrument, Inc. Rotating rate was fixed at 1600 rpm. Electrochemical cell was placed at room temperature.

B6d) Electrochemical measurement: Before loading the carbon catalyst onto the electrode, the Pt ring which is used to detect H₂O₂ was first cleaned by running cyclic voltammetry (CV) in 0.1 M PBS solution (pH=7) at the potential between ˜0.5˜1.1 V (vs. RHE) with a scan rate of 500 mV/s until the Pt ring is clean and CV curve is stable. To deposit the catalyst onto the GC disk electrode, 10.0 mg of carbon catalyst was dispersed in 0.5 mL isopropanol, 0.5 mL ethanol, and 50 μL 5 wt % Nafion solution and ultrasonicated for 1 hour to form a uniform catalyst ink. Then, 3.0 μL of the ink was dropped onto the GC disk of the RRDE, resulting in a catalyst loading of 153 μg cm⁻². The electrolyte 0.1 M PBS was bubbled with ultrapure oxygen at 60 mL/min for 15 min. The GC disk electrode was subjected to potential cycling between 0.25 to 1.1 V (vs. RHE) at a scan rate of 20 mV s⁻¹ with rotating rate of 1600 rpm. 85% of solution ohmic drop (i.e., IR drop) was compensated. The background capacitive current was recorded in the same potential range and scan rate, but in N₂-saturated electrolyte. The current recorded in O₂-saturated solution was corrected by the background current of N₂ to yield ORR current of the tested catalyst. To detect the yield of H₂O₂, the ring potential was set to 1.2 V (vs. RHE) to oxidize the H₂O₂ transferred from GC disk electrode. The H₂O₂ yield was calculated by following equation (Eq. 1):

$${H}_{2} {O}_{2} ( \% ) = 200 \times \frac{{I}_{R} \text{/} {N}_{o}}{( {I}_{R} \text{/} {N}_{o} ) + {I}_{D}} \qquad ( 1 )$$

Where, I_{D} and I_{R} are the disk and ring currents, respectively, and N₀ is the ring collection efficiency. The N₀ was determined to be 0.254 in a solution of 10 mM potassium ferricyanide K₃Fe(CN)₆+1.0 M KNO₃.

B6e) H₂O₂ concentration measurement: The H₂O₂ concentration was measured by traditional cerium sulfate Ce(SO₄)₂ titration method according to the reported literature. Yellow solution of Ce⁴⁺ would be reduced by H₂O₂ to colorless Ce³⁺. Based on this color change, the concentration of Ce⁴⁺ before and after reaction can be measure by UV-vis. The wavelength used for the measurement is 316 nm. According to the reaction below:

2Ce⁴⁺+H₂O₂→2Ce³⁺+2H⁺+O₂

The concentration of H₂O₂ (N) can be determined by:

N=2×N_{Ce}_{⁴⁺}

Where T_{Ce}_{⁴⁺} is the mole of reduced Ce⁴⁺.
The procedure was as follow: prepare 1 mM Ce(SO₄)₂ solution. 33.2 mg Ce(SO₄)₂ was dissolved in 100 mL 0.5 M sulfuric acid solution to form a yellow transparent solution. To obtain the calibration curve, H₂O₂ with known concentration was added to Ce(SO₄)₂ solution and measured by UV-vis. Based on the linear relation between the signal intensity and H₂O₂ concentration (0.2˜1.2 mM), the H₂O₂ concentrations of samples can be obtained. The concentration of H₂O₂ was also determined by using the commercial available hydrogen peroxide testing strip (purchased from Sigma Aldrich).

B6f) Water disinfection: Bacteria (E. coli (JM109, Promega and ATCC K-12)) was cultured to log phase, harvested by centrifugation at 900 g, washed twice with deionized (DI) water and suspended in DI water to ˜106 c.f.u. ml⁻¹ (colony forming units per ml). Bacterial concentrations were measured at different times of illumination using standard spread-plating techniques. Each sample was serially diluted and each dilution was plated in triplicate onto trypticase soy agar and incubated at 37° C. for 18 h.

### B7) Supplemental Figure Descriptions

FIG. 6 shows a cross-sectional SEM image of the N- and O-doped carbon microsheet, indicating the porous structure of the microsheet.

FIG. 7 shows XRD analysis of N- and O-doped carbon catalyst.

FIG. 8 shows the XPS survey spectrum over N- and O-doped carbon. The corresponding compositions are listed in the spectrum, which indicates that no metal signal was found in the sample. The signal of Si involved in the sample was originated from the quartz tube that we used to prepare the N- and O-doped carbon.

FIG. 9 shows results of a stability test of N- and O-doped carbon catalyst for ORR. 2.0 mg N- and O-doped carbon catalyst was loaded on 1 cm² carbon fiber paper. The current density was 4 mAcm⁻².

FIGS. 10A-C show high resolution of XPS of N1s from N- and O-doped carbon catalysts with different N/C ratio.

FIG. 11A shows high resolution of XPS of N1s from N- and O-doped carbon catalyst by introducing melamine as the precursor. FIG. 11B shows RRDE voltammogram measurements of N-doped catalysts with different nitrogen content. The N-doped catalyst with N/C=0.087 was prepared by introducing melamine as the precursor of nitrogen. FIG. 11C shows the corresponding selectivity of H₂O₂ generated in oxygen reduction reaction over N- and O-doped carbon catalysts with different nitrogen content.

1. A method of generating hydrogen peroxide in a pH neutral solution, the method comprising:
providing an electrochemical reaction cell;
providing a mesoporous carbon catalyst including both nitrogen doping and oxygen doping in the electrochemical reaction cell;
providing electrical current to the electrochemical reaction cell to drive an oxygen reduction reaction that produces hydrogen peroxide;
wherein the oxygen reduction reaction is catalyzed by the mesoporous carbon catalyst.

2. The method of claim 1, wherein the method is performed to provide treatment of environmental water.

3. The method of claim 2 wherein the treatment is selected from the group consisting of: disinfection, chemical degradation of pollutants, and any combination thereof.

4. A method of making a catalyst for the electrochemical production of hydrogen peroxide, the method comprising:
providing a nitrogen-containing organic precursor; and
carbonizing the nitrogen-containing organic precursor with a base to provide a mesoporous carbon catalyst including both nitrogen doping and oxygen doping.

5. The method of claim 4, wherein the nitrogen-containing organic precursor has a chemical structure given by 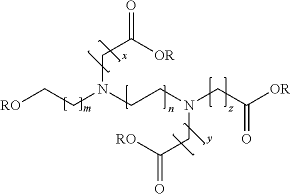
wherein n≥1, m≥1, x≥1, y≥1, z≥1, and wherein each R is independently selected from the group consisting of H, hydrocarbon group, alkali metal ion and alkaline earth metal ion.

6. The method of claim 4, wherein the base is selected from the group consisting of: potassium hydroxide (KOH), sodium hydroxide (NaOH), lithium hydroxide (LiOH), rubidium hydroxide (RbOH), caesium hydroxide (CsOH), ammonium hydroxide (NH₄OH), beryllium hydroxide (BeOH), magnesium hydroxide (Mg(OH)₂), and calcium hydroxide (Ca(OH)₂).

7. The method of claim 4, wherein the carbonizing the nitrogen-containing organic precursor with a base is performed at a temperature in a range from 600° C. to 900° C.

8. A mesoporous carbon catalyst including both nitrogen doping and oxygen doping, wherein the catalyst is configured to catalyze an electrochemical oxygen reduction reaction for the production of hydrogen peroxide in a pH neutral solution.

9. The catalyst of claim 8, wherein the catalyst is configured as porous microsheets of amorphous carbon including nano-scale graphitized domains.

10. The catalyst of claim 8, wherein a nitrogen content of the catalyst is 1% or more, and wherein an oxygen content of the catalyst is 1% or more.

11. The catalyst of claim 8, wherein no transition metal catalyst is included in the mesoporous carbon catalyst.

12. An electrochemical cell for the production of hydrogen peroxide including the catalyst of claim 8.

13. The catalyst of claim 8, wherein the nitrogen doping is in a configuration selected from the group consisting of: pyrrolic configurations, pyridinic configurations and mixtures thereof.
